(19) United States
(12) Patent Application Publication
(10) Pub. No.: US 2006/0257820 A1
(43) Pub. Date: Nov. 16, 2006

(54) Handle for dental/medical instrument

(76) Inventor: Jeffrey Allan Davis, Missoula, MT (US)

Correspondence Address: JONES DAY, 222 EAST 41ST ST, NEW YORK, NY, 10017, US

(21) Appl. No.: 11/129,554

(22) Filed: May 13, 2005

(51) Int. Cl. A61C 3/00

(52) U.S. Cl. 433/141; 433/143

(57) ABSTRACT

A handle for a medical instrument includes an elongate structure with a longitudinal axis, a central portion, and at least one end portion configured to receive a working element. The end portion includes a rigid core and a sleeve configured to fit over the rigid core, and the sleeve includes a rounded gripping surface having a substantially circular cross-sectional configuration and an anti-roll structure having a substantially non-circular cross-sectional configuration. The sleeve may further include a groove extending around its periphery and configured to receive a replaceable identifying element, such as a color-coded band or o-ring. The sleeve may also include a slot that intersects the groove and is configured to receive the tip of a tool used to remove the replaceable identifying element from the groove.

### FIELD OF THE INVENTION

The present invention relates to medical and dental hand instruments, and more particularly, to a medical or dental hand instrument including a body with both an ergonomic, rounded gripping surface and a non-circular, non-gripping surface to prevent unwanted rolling of the instrument and one or more circumferential grooves configured to receive one or more replaceable bands, which may function as identifying elements.

### BACKGROUND OF THE INVENTION

Dental and medical hand instruments are used for manual procedures commonly performed by a medical doctor, dentist or hygienist. Typically, such a hand instrument has a pencil-like handle with a specialized tool, known as a working element, mounted to one or both ends of the handle. Typically, a generally circular or rounded gripping surface on such a handle is preferred for its ergonomic benefits. But hand instruments having generally circular cross-sections will often roll when placed on a tray or other working surface and may fall to the floor or move outside the reach of the attending health care practitioner. Such movement of the instruments when not in use is obviously undesirable. Accordingly, there is a need for a hand instrument, in both the dental and medical fields, having a handle that will prevent such unwanted movement, but still provide the ergonomically desirable, rounded gripping surface. Such a handle should also advantageously include structure for receiving identifying elements, such as color-coded bands or o-rings, which may be easily removed and replaced.

### SUMMARY OF THE INVENTION

A handle for a medical instrument includes an elongated structure with a longitudinal axis, a central portion, and at least one end portion, which includes both an ergonomic, rounded gripping surface and a non-circular, anti-roll structure and is configured to receive at least one working element. The end portion of the handle includes a rigid core and a sleeve configured to fit over the rigid core. The sleeve includes a gripping surface having a substantially circular outermost cross-sectional configuration and a non-gripping, anti-roll structure, having a substantially non-circular, anti-roll structure. The sleeve may further include a groove extending around its periphery and configured to receive a replaceable identifying element, such as a color coded band or o-ring. The sleeve may also include a depression or slot that intersects the groove and is configured to receive the tip of a tool used to remove the replaceable identifying element from the groove.

### BRIEF DESCRIPTION OF THE DRAWINGS

To facilitate an understanding of and for the purpose of illustrating the present invention, exemplary and preferred features and embodiments are disclosed in the accompanying drawings, it being understood, however, that the invention is not limited to the precise arrangements and instrumentalities shown, and wherein similar reference characters denote similar elements throughout the several views, and wherein:

FIG. 1 is a perspective view of a medical/dental hand instrument according to a preferred embodiment of the present invention.

FIG. 2 is a side view of the handle portion of the instrument shown in FIG. 1.

FIG. 3 is an enlarged partial view of one end of the handle portion shown in FIG. 2.

FIG. 4 is a partial lengthwise sectional view taken through one end of the handle portion shown in FIG. 2.

FIG. 5 is s a side view of one end of the instrument shown in FIG. 1.

FIG. 6 is a cross-sectional view taken on line 6-6 of the instrument shown in FIG. 5.

FIG. 7 is an end view taken on line 7-7 of the instrument shown in FIG. 5.

FIG. 8 is a perspective view of the instrument shown in FIG. 5.

FIG. 9 is an enlarged, partial section view of the instrument shown in FIG. 6 showing a groove 34 for receiving an identifying element 126 of FIG. 6.

### DETAILED DESCRIPTION OF THE PREFERRED EMBODIMENTS

The apparatus 10 shown in the drawings is a medical/dental hand instrument with parts that are examples of the structural elements recited in the claims. The hand instrument 10 thus includes examples of how a person of ordinary skill in the art can make and use the invention, and is described here to provide enablement and best mode of the invention without imposing limitations that are not recited in the claims.

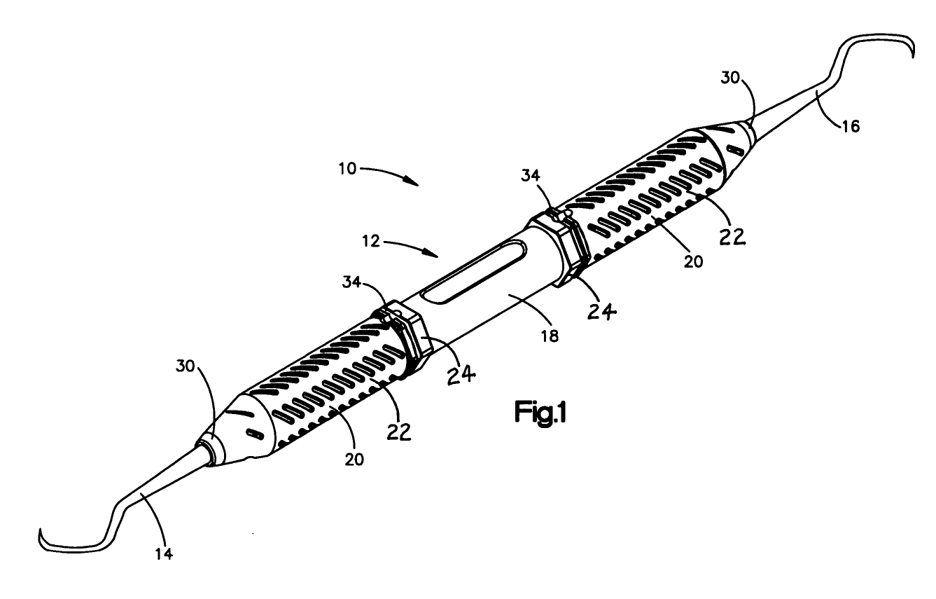

As shown in FIG. 1, the hand instrument 10 has a handle 12 and working elements 14 and 16 at either end of the handle 12. In the illustrated example, the hand instrument 10 is a dental curette, but the handle 12 may be used with a variety of working elements that differ from those shown in FIG. 1, including dental mirrors, etc. The handle 12 includes a central portion 18, two opposing end portions 20, and two opposing collars 30. Each end portion 20 extends between the central portion 18 and one of the collars 30, and includes a ergonomic, rounded or generally circular gripping surface 22 and a generally non-circular anti-roll structure 24. Each opposing working element 14 or 16 protrudes beyond its adjacent collar 30. Close to the central portion 18, each end portion 20 has a groove 34 that extends around the perimeter of end portion 20.

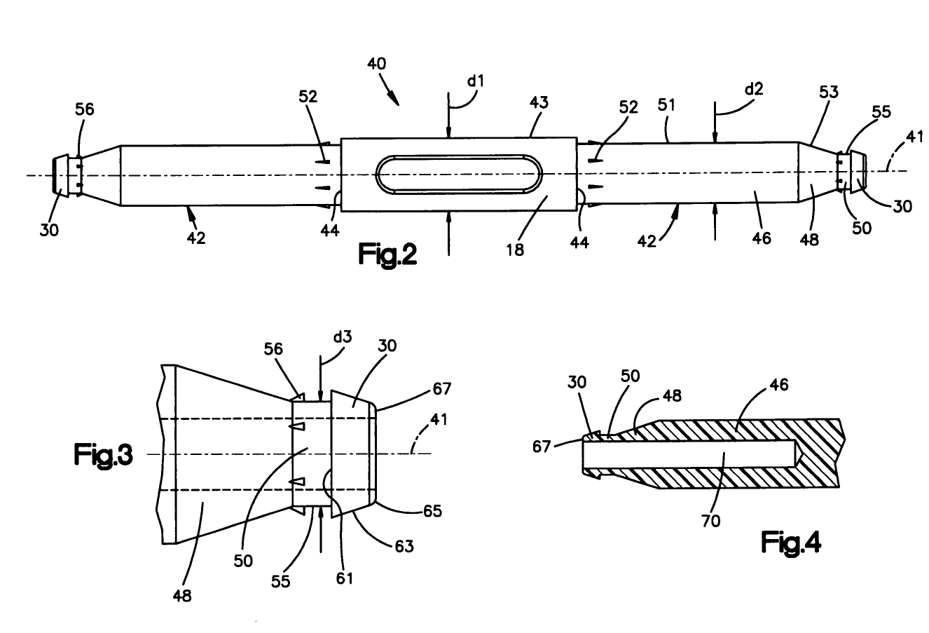

FIG. 2 shows a rigid core component 40 of the handle 12. The core 40 has a generally cylindrical configuration along a longitudinal central axis 41, and includes the central portion 18 of the handle 12 and the two collars 30. The central portion 18 of the handle 12 is a short cylindrical piece that has an external surface 43 with an outer diameter d1, and is bound between two annular abutment surfaces 44 on either end. Two intermediate sections 42 of the core 40 extend axially from the central portion 18 to the collars 30. Starting from its proximal end adjacent to the central portion 18, each intermediate section 42 has three adjacent parts: a substantially cylindrical body 46, a conical part 48, and a cylindrical cuff 50.

Each cylindrical body 46 extends longitudinally from the adjacent abutment surface 44 of the central portion 18. The outer surface 51 of each cylindrical body 46 has an outer diameter d2 that is smaller than the outer diameter d1 of the central portion 18. Additionally, each cylindrical body 46 has an array of burrs or barbs 52 arranged circumferentially about its outer surface 51 close to the central portion 18. Each burr 52 has a triangular cross-section with the base of the triangle facing the central portion 18.

The conical parts 48 of the intermediate sections 42 are located immediately adjacent the distal ends of the cylindrical bodies 46. Each conical part 48 has an outer surface 53 that has a larger diameter proximally than distally, and provides a transition between the cylindrical body 46 and the cylindrical cuff 50.

As depicted in greater detail in FIG. 3, each cuff 50 is a small cylindrical piece that extends distally from the narrower end of the conical part 48. The cuff 50 has an outer surface 55 with an outer diameter d3 that is smaller than the outer diameter d2 of the cylindrical body 46. Positioned on the outer surface 55, adjacent to the conical part 48, is a second array of burrs 56 arranged circumferentially about the central axis 41. Like the burrs 52, the burrs 56 also are triangular in cross-section. However, the burrs 56 and 52 face in axially opposite directions.

The collar 30 also is shown in greater detail in FIG. 3. Surfaces of the collar 30 include a planar abutment surface 61 proximally, a major conical outer surface 63, and a minor conical outer surface 65 which transitions into a planar end surface 67. The proximal abutment surface 61 has an annular shape and is located adjacent to the cuff 50. The end surface 67 defines the distal end of the handle 12.

FIG. 4 depicts a counterbore 70 within the handle 12. The counterbore 70 extends axially inwards from the end surface 67 through the collar 30, the cuff 50, the conical part 48, and partly through the cylindrical body 46 of the intermediate section 42. The counterbore 70 is sized to receive a shaft portion of working element 14 or 16, shown in FIG. 1.

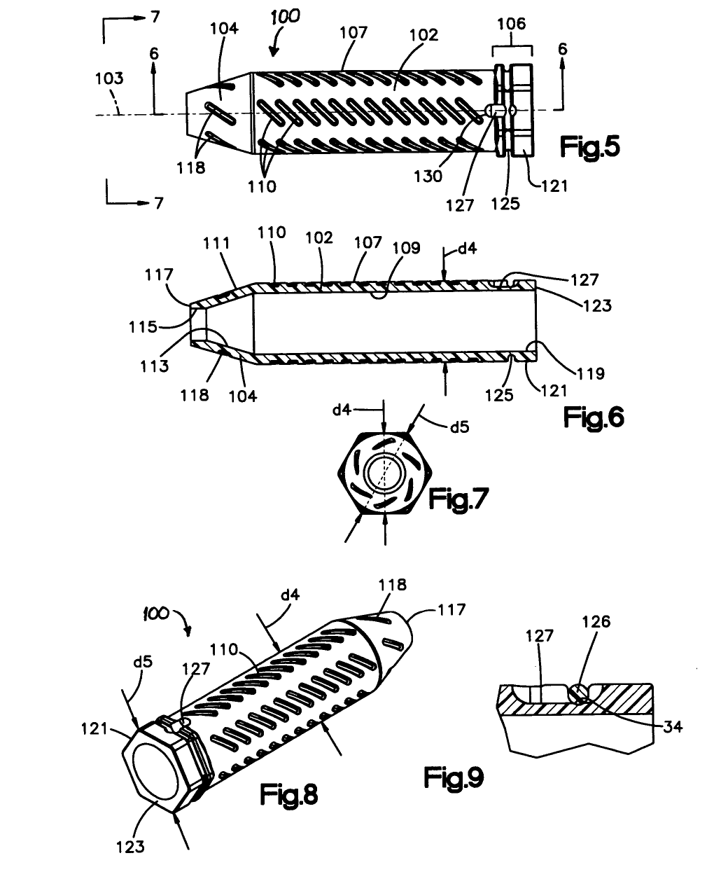

FIGS. 5-8 show a sleeve 100 that is one of a pair of elastomeric sleeves that form end portions 20 of handle 12. Like the intermediate sections 42 of the core 40, the sleeves 100 are identical, and each sleeve 100 is configured to fit over an intermediate section 42. Each sleeve 100 has an elongated tubular body 102 with a longitudinal central axis 103, a distal end segment 104, and a proximal end segment 106. The tubular body 102 has a substantially circular cross-sectional configuration with an outer surface 107, an inner surface 109, and an outer diameter d4. (FIG. 6). Disposed on the outer surface 107 are axially extending rows of identical depressions or slots 110. Each depression 110 is recessed a short distance downward from the outer surface 107, and has an elongated linear configuration with rounded opposite ends. Depressions 110 are parallel and equally spaced apart from each other and extend in directions that, when viewed from the side, are at an oblique angle to the central axis 103. Outer surface 107 and depressions 110 of elastomeric sleeve 100 provide a rounded and cushioned ergonomic gripping surface 22 (shown in FIG. 1).

The distal end segment 104 of each sleeve 100 is a short conical structure that extends distally from the tubular body 102. As shown in FIG. 6, the distal end segment 104 has a conical outer surface 111, a conical inner surface 113 that follows the contour of the outer surface 111, and a cylindrical inner surface 115. An annular end surface 117 faces axially and defines the distal end of the sleeve 100. An array of slots 118 is positioned circumferentially about the outer surface 111 of the distal end segment 104. Each slot 118 is of substantially the same size, depth, and angle of the slots 110 on the tubular body 102.

The proximal end segment 106 of each sleeve 100 is a radially enlarged tubular structure located at the proximal end of the tubular body 102. The inner surface 119 (FIG. 6) of the proximal end segment 106 has a circular cross-sectional configuration and is continuous with the inner surface 109 of the tubular body 102. The outer surface 121 of the proximal end segment 106 has a non-circular cross-sectional configuration with an outermost dimension d5 that is greater than the outermost dimension d4 of the tubular body 102 (FIG. 7). The non-circular cross-sectional configuration of the outer surface 121 is preferably polygonal, and in the illustrated example is hexagonal. Non-circular, outer surface 121 forms anti-roll structure 24, which prevents unwanted rolling of the instrument when not in use. An annular end surface 123 faces axially and has a hexagonal outer periphery and a circular inner periphery.

A recessed surface 125 defines the groove 34, noted above with reference to FIG. 1. The groove 34 extends around the entire periphery of the outer surface 121 of the proximal end segment 106, and is situated on the distal half of the end segment 106. Preferably, the peripheral cross-sectional configuration of the groove 34 matches that of the outer surface 121, which in the illustrated example is hexagonal. An o-ring 126 configured to sit within the groove 34 is shown in FIG. 9. O-ring 126 acts as an identifying element and may be color coded to indicate an instrument family, size, type, etc. While shown as an o-ring in this embodiment, identifying element 126 may take the form of a band or similar suitable structure. Another recessed surface 127 defines a depression or slot 130. Depression 130 extends axially across the groove 125 and a short distance beyond the groove 34 in axially opposite directions. In this particular implementation, the depression 130 has the same depth as the groove 125, and enables easy removal of identifying element 126.

To form the end portions 20 of the handle 12, each sleeve 100 is received over an intermediate section 42 of the core 40. Each sleeve 100 is configured to fit snuggly over the respective intermediate section 42, with the inner surfaces 119, 109, 113 and 115 of the sleeve 100 adjoining and overlying the outer surfaces 51, 53, and 55 of the intermediate section 42. Once in place, the sleeve 100 is captured axially between the abutment surfaces 44 and 61. Burrs 52 and 56 help to hold the sleeve 100 in place. The sleeve may also be secured to the intermediate section 42 using an adhesive or other fastening means.

As discussed briefly above, end portions 20 of handle 12 have several functions. The shape, softness and surface texture of the gripping surface 22 are ergonomically designed to reduce the user's finger muscle fatigue. The non-circular structure 24 provided by polygonal outer surface 121 of the sleeves 100 adds an anti-roll feature to the handle 12. The grooves 34 can receive color-coded identifying elements, such as o-ring 126, to distinguish and identify different instrument types, sets and/or sizes. Moreover, each depression or slot 130 can receive the tip of an instrument to ease the removal of the color-coded identifying element 126 from the handle 12.

The patentable scope of the invention is defined by the claims, and may include other examples of how the invention can be made and used. Such other examples, which may be available either before or after the application filing date, are intended to be within the scope of the claims if they have structural elements that do not differ from the literal language of the claims, or if they have equivalent structural elements with insubstantial differences from the literal language of the claims.

What is claimed is:

1. A handle for a medical/dental instrument comprising:
an elongated structure having a longitudinal axis, a central portion, at least one end portion configured to receive a working element;
the at least one end portion including a rigid core and a sleeve configured to fit over the rigid core;
wherein the sleeve includes a rounded gripping surface having a substantially circular outer cross-sectional configuration and an anti-roll structure having a substantially non-circular outer cross-sectional configuration.

2. The handle of claim 1, further comprising a second end portion.

3. The handle of claim 1, wherein the second end portion includes a rigid core and a sleeve configured to fit over the rigid core, and the sleeve includes a rounded gripping surface having a substantially circular cross-sectional configuration and an anti-roll structure having a substantially non-circular cross-sectional configuration.

4. The handle of claim 1, wherein the sleeve has a substantially circular inner cross-sectional configuration.

5. The handle of claim 1, wherein the anti-roll structure has a polygonal outer cross-sectional configuration.

6. The handle of claim 5, wherein the anti-roll structure has a hexagonal outer cross-sectional configuration.

7. The handle of claim 1, further comprising at least one dental working element at the at least one end portion.

8. The handle of claim 1, further comprising at least one medical working element at the at least one end portion.

9. The handle of claim 2, wherein each end portion is configured to receive a respective working element.

10. The handle of claim 7, wherein the working element is removable.

11. The handle of claim 1, wherein the gripping surface of the sleeve includes a plurality of axially extending rows of depressions, said rows being equally spaced apart from each other and said depressions being at an oblique angle to the longitudinal axis of said handle.

12. The handle of claim 11, wherein the depressions in each row are parallel and equally spaced from each other.

13. The handle of claim 1, wherein the sleeve is formed of an elastomeric material.

14. The handle of claim 1, wherein the rigid core includes a plurality of burrs disposed on a peripheral surface to secure the sleeve in position on the rigid core.

15. The handle of claim 1, wherein the sleeve includes a groove around a perimeter of the sleeve configured to receive a replaceable identifying element.

16. The handle of claim 15, further comprising a replaceable, identifying element configured to be received within the groove.

17. The handle of claim 16, wherein the identifying element is an o-ring color-coded to indicate a particular instrument set, type or size.

18. The handle of claim 15, further comprising a slot formed on the sleeve and intersecting the groove, and configured to receive the tip of a tool used to remove the replaceable identifying element from the groove.

19. The handle of claim 18, wherein the slot is parallel to the longitudinal axis of the handle.

20. The handle of claim 18, wherein the slot has the same depth as the groove.

21. A handle for a medical/dental instrument comprising:
an elongated structure having a longitudinal axis, a central portion, and at least one end portion configured to receive a working element;
the at least one end portion including
a rigid core having a plurality of burrs formed on a peripheral surface of the rigid core; and
an elastomeric sleeve configured to fit over the rigid core, the sleeve having a rounded and cushioned gripping surface with a substantially circular outer cross-sectional configuration and an anti-roll structure with a substantially non-circular outer cross-sectional configuration;
wherein the burrs formed on the rigid core secure the sleeve in position on the rigid core and the sleeve includes a groove extending around its periphery and configured to receive a replaceable identifying element.

22. The handle of claim 21, further comprising a second end portion having a rigid core and a sleeve configured to fit over the rigid core, the sleeve including a rounded gripping surface having a substantially circular cross-sectional configuration and an anti-roll structure having a substantially non-circular cross-sectional configuration.

23. The handle of claim 21, wherein the anti-roll structure has a polygonal outer cross cross-sectional configuration.

24. The handle of claim 21, further comprising at least one dental working element at the at least one end portion.

25. The handle of claim 21, wherein the gripping surface of the sleeve includes a plurality of axially extending rows of depressions, said rows being equally spaced apart from each other and said depressions being at an oblique angle to the longitudinal axis of said handle.

26. The handle of claim 25, wherein the depressions in each row are parallel and equally spaced from each other.

27. The handle of claim 21, further comprising a replaceable, identifying element configured to be received within the groove on the sleeve.

28. The handle of claim 27, wherein the identifying element is an o-ring color-coded to indicate a particular instrument set, type or size.

29. The handle of claim 21, further comprising a slot formed on the sleeve that intersects the groove and is configured to receive the tip of a tool used to remove the replaceable identifying element from the groove.

30. The handle of claim 29, wherein the slot is parallel to the longitudinal axis of the handle.

31. The handle of claim 29, wherein the slot has the same depth as the groove.
